(19) United States
(12) Patent Application Publication
(10) Pub. No.: US 2015/0116865 A1
(43) Pub. Date: Apr. 30, 2015

(54) DISK DRIVE DEVICE AND MANUFACTURING METHOD OF A DISK DRIVE DEVICE

(71) Applicant: Samsung Electro-Mechnaics Japan Advanced Technolog Co., Ltd., Shizuoka (JP)

(72) Inventor: Masafumi MIZUNO, Shizuoka (JP)

(21) Appl. No.: 14/517,975

(22) Filed: Oct. 20, 2014

(30) Foreign Application Priority Data
Oct. 31, 2013 (JP) 2013-226110

(51) Int. Cl. G11B 19/20; G06F 1/18

(52) U.S. Cl. CPC G11B 19/2036; G06F 1/183
USPC 360/99.08

(57) ABSTRACT

A disk drive device includes a stationary member and a rotatable member rotatably supported by the stationary member about a rotation axis. The rotatable member includes a cylindrical part, which fits in a center hole of a recording disk, and a placement part protruding radially outward from the cylindrical part in a direction of the rotation axis. The cylindrical part includes an external thread groove formed on an outer peripheral surface thereof. The external thread groove engages with a thread groove of a clamper to clamp the recording disk. The cylindrical part includes a small inner-edge inclined surface, which is a tapered annular surface formed on an end of the cylindrical part so that the external thread groove begins forming from the small inner-edge inclined surface. The small inner-edge inclined surface has an inner circumferential edge having a diameter smaller than a thread bottom diameter of the external thread groove.

### CROSS-REFERENCE TO RELATED APPLICATIONS

This application is based upon and claims the benefit of priority of Japanese Patent Application No. 2013-226110 filed on Oct. 31, 2013, the entire contents of which are incorporated herein by reference.

### BACKGROUND OF THE INVENTION

1. Field of the Invention

The present invention generally relates to a disk drive device and a manufacturing method of a disk drive device.

2. Description of the Related Art

In a disk drive device such as, for example, a hard disk drive unit, a recording disk is mounted to a rotatable member that is rotatably supported by, for example, a dynamic pressure fluid bearing. The recording disk is configured to rotate together with the rotatable member being rotated. Such a disk drive device is disclosed in Japanese Laid-Open Patent Application No. 2009-162246.

In the disk drive device, the recording disk is placed on a placement part provided on an outer circumferential edge of the rotatable member while a center opening of the recording disk fits onto a fitting part of the rotatable member. The recording disk is fixed to the rotatable member by being clamped between the placement part and a fixing member that fits onto the fitting part from above the recording disk.

In the above-mentioned structure of fixing the recording disk, a threaded part may be provided to each of the fixing member and the fitting part of the rotatable member so that the fixing member is engaged with the fitting part of the rotatable member by screwing the fixing member to the fitting part, thereby preventing the recording disk from being disconnected or displaced during a conveyance or an operation of the disk drive device.

However, in such a structure of screwing the fixing member to the fitting part of the rotatable part from the upper-end side of the fitting part, an incomplete thread formed on the upper end of the fitting part of the rotatable member may be deformed in a downward manner. Here, the incomplete thread is a part of the thread formed on the upper-end portion of the fitting part, which part includes an incomplete thread ridge having a sharp top. Such an incomplete thread is inevitably formed when forming a thread on the fitting part of the rotatable member.

If the incomplete thread on the upper-end portion of the fitting part deforms, it becomes difficult to screw the fixing member to the fitting part, which may result in deterioration of workability in the manufacturing process. Additionally, even if the fixing member can be screwed to the fitting part having the incomplete thread, the incomplete thread may be cut off and fall inside the disk drive device, which may cause a malfunction of the disk drive device.

### SUMMARY OF THE INVENTION

The present invention may provide a disk drive device that substantially obviates one or more of the problem's caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a disk drive device particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a disk drive device including a stationary member including a base and a rotatable member rotatably supported by the stationary member about a rotation axis via a dynamic pressure fluid bearing mechanism. The rotatable member includes a hub having a cylindrical part configured to fit in a center hole of a recording disk and a placement part protruding radially outward from a first end portion of the cylindrical part in a direction of the rotation axis of the rotatable member. The cylindrical part includes an external thread groove formed on an outer peripheral surface thereof. The cylindrical part further includes a small inner-edge inclined surface, which is a tapered annular surface formed on a second end portion of the cylindrical part opposite to the first end portion so that the external thread groove begins from the small inner-edge inclined surface. The small inner-edge inclined surface has an inner circumferential edge at which the small inner-edge inclined surface connects to an end surface of the second end portion of the cylindrical part, and the inner circumferential edge has a diameter smaller than a thread bottom diameter defined by a deepest bottom part of the external thread groove.

There is provided according to another aspect of the invention a disk drive device including a rotatable member rotatably supported about a rotation axis, the rotatable member including a cylindrical part configured to fit in a center hole of a recording disk and a placement part protruding radially outward from a first end portion of the cylindrical part in a direction of the rotation axis. An external thread groove is formed on an outer peripheral surface of the cylindrical part, the external thread groove configured to engage with an internal thread groove of a clamper to clamp the recording disk. A small inner-edge inclined surface, which is a tapered annular surface formed on a second end portion of the cylindrical part opposite to the first end portion so that the external thread groove begins forming from the small inner-edge inclined surface. The small inner-edge inclined surface has an inner circumferential edge at which the small inner-edge inclined surface connects to an end surface of the second end portion of the cylindrical part. The inner circumferential edge has a diameter smaller than a thread bottom diameter defined by a deepest bottom part of the external thread groove. An angle α formed between the small inner-edge inclined surface and a plane perpendicular to the rotation axis and an angle β formed between a slope of a thread of the external thread groove and a plane perpendicular to the rotation axis satisfy a relationship β≦α≦2β.

There is provided according to another aspect of the invention a method of manufacturing. the above-mentioned disk drive device. The method includes forming the small inner-edge inclined surface on a workpiece to be formed into the rotatable member, and forming, after forming the small inner-edge inclined surface, the external thread groove on the workpiece.

Other objects and features of the present invention will be apparent from the following detailed description when read in conjunction with the accompanying drawings.

### BRIEF DESCRIPTION OF THE DRAWINGS

FIGS. 1A-1C are schematic diagrams illustrating a disk drive device according to an embodiment;

FIG. 2 is a cross-sectional view of a part of the disk drive device according to the embodiment;

FIG. 3 is an enlarged cross-sectional view of a portion of a hub of the disk drive device according to the embodiment;

FIG. 4 is an enlarged cross-sectional view of a part of the hub having an inclined surface;

FIG. 5 is a plan view of the hub having the inclined surface;

FIGS. 6A-6F are enlarged cross-sectional views of the portion of the hub having the inclined surface; and

FIG. 7 is an enlarged cross-sectional view of the portion of the hub having the inclined surface for explaining a manufacturing process of the hub.

### DESCRIPTION OF EMBODIMENTS

In the following, an embodiment of the present invention will be described with reference to the accompanying drawings. Throughout the drawings, equivalent components/parts are denoted with the same reference numerals and a detailed explanation may be omitted where appropriate. In the detailed description of the embodiment of the present invention, the sizes of constituent elements may be enlarged or reduced in the drawings for aiding understanding of the embodiment of the present invention. Some of the components/parts in the drawings may be omitted for the sake of convenience in the explanation of the embodiment.

A disk drive device according to the embodiment described below is capable of rotating, for example, a recording disk on which data can be recorded magnetically, and may be used as a hard disk drive unit.

### Configuration of Disk Drive Device

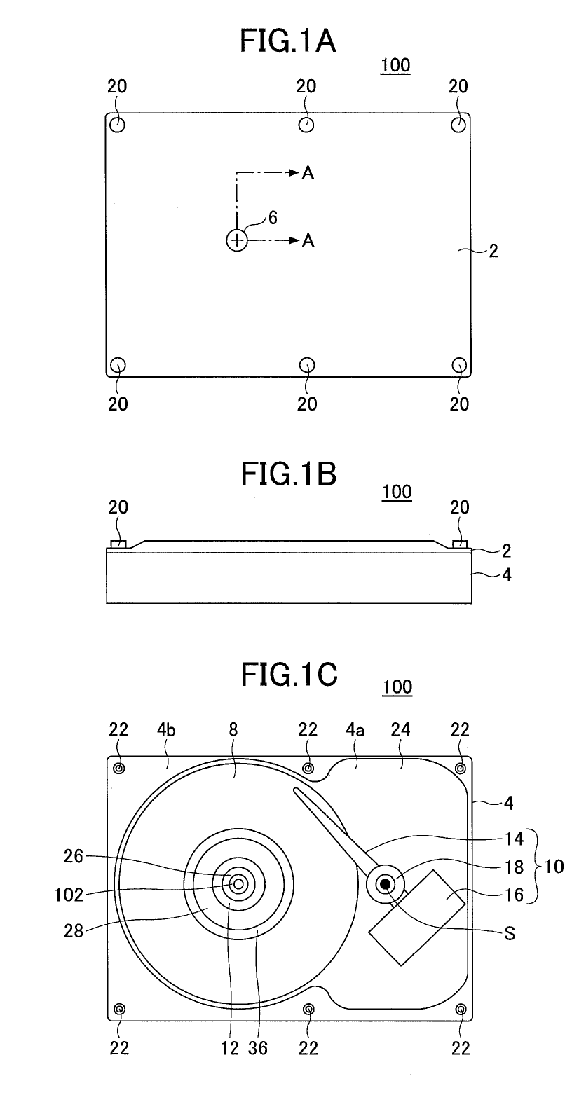

FIGS. 1A-1C illustrate a disk drive device 100 according to an embodiment of the present invention. FIG. 1A is a plan view of the disk drive device 100. FIG. 1B is a side view of the disk drive device 100. FIG. 10 is a plan view of the disk drive device 100 where a top cover 2 is removed.

The disk drive device 100 includes the top cover 2, a base 4, a recording disk 8, a data read/write part 10, a cap 12, a shaft 26, a hub 28, a clamper 36 and a housing 102.

A description is given below on the assumption that, in a state where the top cover 2 is attached to the base 4, the side where the top cover 2 is located is an upper side and the side where the base 4 is located is a lower side. A direction parallel to the rotating direction of the recording disk 8 is referred to as an axial direction. An arbitrary direction passing through the axial direction and parallel to a plane perpendicular to the axial direction is referred to as a radial direction. A farther side from the rotating axis in a radial direction is referred to as an outer periphery side, and a closer side to the rotating axis is referred to as an inner periphery side. These notations or definitions do not limit a position of the disk drive device 100 when it is used, and the disk drive device 100 may be used in an arbitrary position.

(Top Cover)

The top cover 2 can be formed by pressing, for example, an aluminum plate or a steel plate. The top cover 2 may be applied with a surface treatment such as plating in order to prevent corrosion.

The top cover 2 is fixed onto a top surface of the base 4 with peripheral screws 20. The top cover 2 and the base 4 are tightly fixed to each other to hermetically seal an interior space formed by the top cover 2 and the base 4. A fixing screw 6 is inserted into an opening formed at the center of the top cover 2, and is connected with a fixing screw hole formed in a housing 102 that is fixed to the base 4.

(Base)

As illustrated in FIG. 10, the base 4 includes a bottom plate 4a that forms a bottom part of the disk drive device 100 and an outer peripheral wall 4b that is formed along the outer periphery of the base plate 4a in a manner surrounding an area for mounting the recording disk 8. Screw holes 22 are provided on the top surface of the outer peripheral wall 4b of the base 4 so that the peripheral screws 20 can be screwed into the screw holes 22.

The top cover 2 is fixed onto the top surface of the outer peripheral wall 4b of the base 4 by the peripheral screws 20 being screwed into the screw holes 22. A disk accommodating space 24 is formed by being surrounded by the bottom plate 4a and the outer peripheral wall 4b of the base 4 and the top cover 2. The disk accommodating space 24 is isolated from an external environment. The disk accommodating space 24 is filled with clean air containing a less amount of dusts or the like. Accordingly, the recording disk 8 is suppressed from being adhered with foreign particles, thereby reducing a possibility of failure occurring in an operation of the disk drive device 100.

The base 4 can be formed by, for example, performing a die cast process using an aluminum alloy. The base 4 may be formed by performing a pressing process using a metal plate such as an aluminum plate or a stainless steel plate. In the case of using a pressing process, an emboss process may be applied in which convex parts are formed on an upper side of the base 4. By applying the emboss process to a predetermined part of the base 4, the base 4 can be prevented from deforming.

The base 4 may include a plating layer formed of a metal material such as, for example, nickel, chrome, etc., or a coating layer formed of a resin material such as epoxy resin. According to such a surface treatment layer, the base 4 is prevented from having surface peeling. Moreover, if the magnetic recording disk 8 is brought into contact with a surface of the base 4 during a manufacturing process of the disk drive device 100, a possibility of damage in the surface of the base 4 and the magnetic recording disk 8 is reduced. Further, the plating layer can provide a smaller coefficient of friction and a higher surface hardness of the base 4 than that of the coating layer of a resin material, thereby further reducing the possibility of damage on the surface of the base 4 and the recording disk 8 due to a contact.

(Data Read/Write Part)

The data read/write part 10 includes a recording/reproducing head (not illustrated in the figures), a swing arm 14, a voice coil motor 16 and a pivot assembly 18. The recording/reproducing head is attached to an end of the swing arm 14. The recording/reproducing head records data on the recording disk 8, and reads data from the recording disk 8. The pivot assembly 18 swingably supports the swing arm 14 about a head rotation axis S. The recording/reproducing head is moved to a desired position above the magnetic recording disk 8 by driving the swing arm 14 by activating the voice coil motor 16. The voice coil motor 16 and the pivot assembly 18 can be constituted according to a known technique to control a head position.

(Recording Disk)

The recording disk 8 is, for example, a 2.5 inch type recording disk that is formed of glass. The recording disk 8 has a diameter of 65 mm and a thickness of 0.65 mm. A center hole that is fitted to the hub 28 has a diameter of 20 mm. In the disk drive device 100 according to the present embodiment, one piece of the recording disk 8 is mounted to an outer periphery of the hub 28.

### Configuration of Bearing Mechanism

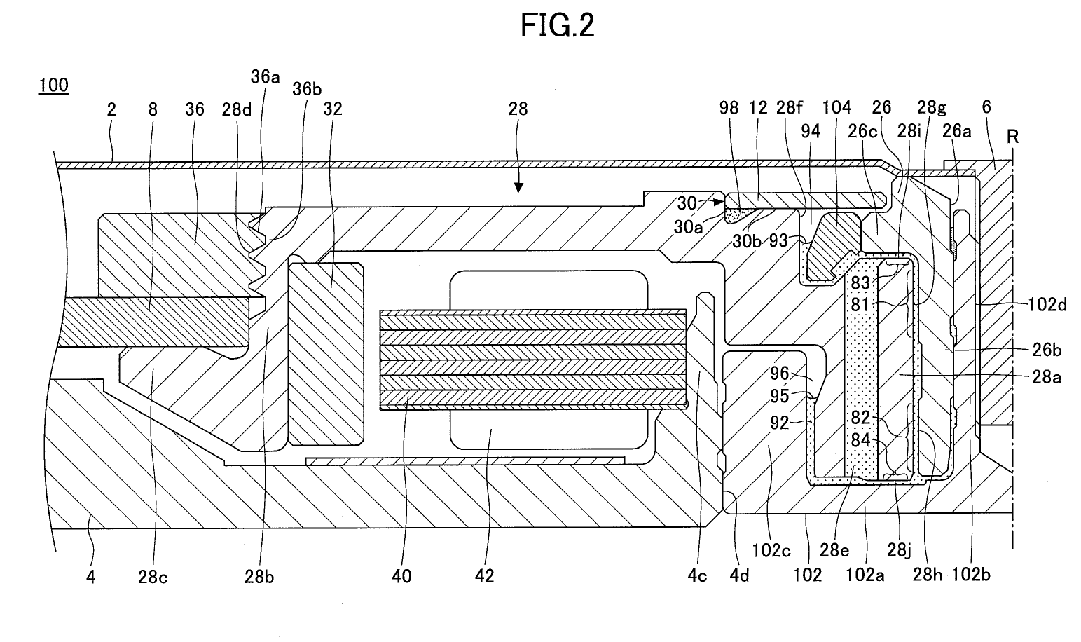

FIG. 2 is a cross-sectional view of the disk drive device 100 taken along a line A-A of FIG. 1A. FIG. 2 illustrates a configuration of a dynamic pressure fluid bearing mechanism of the disk drive device 100 according to the present embodiment.

The disk drive device 100 includes, as a stationary part or member, the base 4, the shaft 26, a stator core 40, a coil 42, the housing 102 and a ring member 104. Additionally, the disk drive device 100 includes, as a rotatable part or member, the cap 12, the hub 28, a cylindrical magnet 32 and a clamper 36. Further, the disk drive device 100 includes the clamper 36 as a fixing member to fix the recording disk 8 to the hub 28.

In the disk drive device 100, a lubricant 92 is put into a gap between the hub 28 and each of the shaft 26, the housing 102 and the ring member 104. The rotatable member including the hub 28 to which the recording disk 8 is mounted is rotatably supported by the stationary member including the shaft 26.

(Hub)

The hub 28 can be formed by, for example, performing a machining process or a pressing process on a steel material such as, for example, SUS430 having a soft magnetism (a soft magnetic material). A surface treatment such as, for example, electroless nickel plating may be applied to the hub 28 to form a plated layer on the surface of the hub 28 in order to suppress peeling of minute residues adhering on the processed surface of the hub 28. Although the hub 28 according to the present embodiment is formed into a single piece member, the hub 28 may be formed by a plurality of members combined into a single piece.

The hub 28 includes a shaft surrounding part 28a surrounding the shaft 26, a fitting part 28b fitting into a center hole 8a of the recording disk 8, and a placement part 28c on which the recording disk 8 is placed. Additionally, the hub 28 includes an external thread groove 28d formed on an outer peripheral surface of the fitting part 28b with which the clamper 36 engages. The hub 28 further includes a communication path 28e, which extends between a top surface and a bottom surface of the shaft surrounding part 28a, to communicate the upper side of the top surface of the shaft surrounding part 28a with the lower side of the bottom surface of the shaft surrounding part 28a. The communication path 28e is provided to reduce a difference in pressure applied to the lubricant 92 in an area where the lubricant 92 is put into the above-mentioned gap between the hub 28 and each of the shaft 26, the housing 102 and the ring member 104 in order to stabilize the rotation of the hub 28.

The center hole 8a of the magnetic recording disk 8 fits to the cylindrical part 28b of the hub 28, and the recording disk 8 is fixed to the hub 28 by being clamped by the clamper 36 and the placement part 28c. Accordingly, the recording disk 8 rotates together with the hub 28.

(Clamper)

The clamper 36 is formed into a disk-like shape having a screw hole 36b. An internal thread groove 36a is formed on an inner peripheral surface of the screw hole 36b. The internal thread groove 36a of the clamper 36 engages with the external thread groove 28d formed on the outer peripheral surface of the fitting part 28b of the hub 28. The clamper 36 can be formed by cutting a steel material such as, for example, SUS303, which is a stainless steel. The clamper 36 is fixed to the hub 28 by being engaged with the external thread groove 28d formed on the outer peripheral surface of the fitting part 28b of the hub 28. The clamper 36 presses the recording disk 8 against the placement part 28c of the hub 28 in order to fix the recording disk 8 to the hub 28.

(Cylindrical Magnet)

The cylindrical magnet 32 is fixed to the inner peripheral surface of the fitting part 28b of the hub 28 by an adhesive. The cylindrical magnet 32 is formed of, for example, a ferrite magnetic material or a rare earth magnetic material that contains a resin material such as polyamide as a binder. The cylindrical magnet 32 may be formed of, for example, a lamination of a ferrite magnet layer and a rare earth magnet layer.

The cylindrical magnet 32 is provided with, for example, twelve magnetic poles arranged in a circumferential direction of the inner peripheral surface thereof. The inner peripheral surface of the cylindrical magnet 32 opposes to the outer peripheral surface of the stator core 40 in a radial direction so that salient poles formed by the stator core 40 face the magnetic poles of the cylindrical magnet 32 with a predetermined gap therebetween.

(Stator Core)

The stator core 40 includes a circular ring part and nine pieces of the salient poles extending toward the outer peripheral side from the circular ring part. The stator core 40 is fixed to the outer peripheral surface of a protruding part 4c, which cylindrically protrudes from a bottom surface of the base 4, by press fitting or loose fitting. The stator core 40 is formed by laminating, for example, six thin electromagnetic steel sheets each having a thickness of 0.2 mm into one piece by caulking. Insulation painting or coating such as, for example, electrodeposition coating or powder coating is applied onto the surface of the stator core 40. A coil 42 is formed by winding conductive wire such as copper wire or the like on each of the salient poles of the stator core 40. A drive magnetic flux is generated along each of the salient poles by causing an electric current flowing through the coil 42. It should be noted that the stator core 40 may be a solid core made of a sintered material, which is formed by solidifying magnetic powders.

(Housing)

The housing 102 is fixed to the base 4, and rotatably supports the hub 28 in cooperation with the shaft 26 that is fixed to and supported by the housing 102. The housing 102 includes a flat and annular bottom part 102a, a protruding part 102b and a cylindrical part 102c. The protruding part 102b protrudes upward from the inner periphery of the bottom part 102a. The cylindrical part 102c protrudes upward from the outer periphery of the bottom part 102a, and surrounds the lower end of the shaft surrounding part 28a of the hub 28.

The housing 102 is fixed to the base 4 by the cylindrical part 102c being press fitted in or bonded to a center hole 4d provided in the inner periphery of the protruding part 4c of the base 4.

The center of the center hole 4d coincides with the rotation axis R.

The protruding part 102b is provided with a fixing screw hole 102d into which the fixing screw 6 is inserted from an upper end of the protruding part 102 along the axial direction. The top cover 2 is fixed by the fixing screw 6 being engaged with the fixing screw hole 102d.

(Shaft)

The shaft 26 includes a support hole 26a having a center that coincides with the rotation axis R. The shaft 26 is fixed to and supported by the protruding part 102b of the housing 102 being press fitted into the support hole 26a. The shaft 26 includes a cylindrical part 26b and a flange part 26c. The cylindrical part 26b surrounds the protruding part 102b of the housing 102. The flange part 26c protrudes annularly and radially outward from the upper end of the cylindrical part 26b.

The ring member 104 having an annular shape is fixed to the outer peripheral surface of the flange part 26c by press fitting with an adhesive. The adhesive provided between the flange part 26c and the ring member 104 serves as a sealing material to prevent the lubricant 92 from leaking through a gap between the flange part 26c and the the ring member 104.

(Lubricant and Seal Structure)

The lubricant 92 is put into the gap between the hub 28 and each of the shaft 26, the housing 102 and the ring member 104 and also put into the communication path 28e of the hub 28. The lubricant 92 contains basic oil added with fluorescent material or phosphor so that, if the lubricant 92 leaks between the members, the leakage can be easily detected by irradiating a light having a predetermined wavelength to an area where the lubricant 92 may leak.

A first air/liquid interface 93 is formed between the ring member 104 and the inner peripheral surface 28f of the hub 28 facing the ring member 104 in a radial direction.

A tapered surface is formed in the outer peripheral surface of the ring member 104 so that a distance between the outer peripheral surface of the ring member 104 and the inner peripheral surface 28f of the hub 28 increases in an upward direction. According to such a structure, a first seal part 94 is formed between the side surface of the ring member 104 and the inner peripheral surface 28f of the hub 28. The first seal part 94 is a taper-shaped space having a radial width increasing in an upward direction. In the first seal part 94, a downward force is exerted on the lubricant 92 to move the lubricant 92 downward according to a capillary phenomenon. Thus, the lubricant 92 is confined in the space between the ring member 104 and the inner peripheral surface 28f of the hub 28.

Moreover, a second air/liquid interface 95 is formed between the lower end outer peripheral surface of the shaft surrounding part 28a of the hub 28 and the inner peripheral surface of the cylindrical part 102c of the housing 102.

A tapered surface is provided in the outer peripheral surface of the shaft surrounding part 28a of the hub 28 so that a distance between the outer peripheral surface of the shaft surrounding part 28a of the hub 28 and the inner peripheral surface of the cylindrical part 102c of the housing 102 increases in an upward direction. According to such a form, a second seal part 96 is formed between the outer peripheral surface of the shaft surrounding part 28a of the hub 28 and the inner peripheral surface of the cylindrical part 102c of the housing 102. The second seal part 96 is a space having a tapered shape in which a radial distance between the hub 28 and the housing 102 gradually increases in an upward direction. Accordingly, in the second seal part 96, a downward force is exerted on the lubricant 92 to move the lubricant 92 downward according to a capillary phenomenon. Thus, the lubricant 92 is confined in the space between the hub 28 and the housing 102.

(Cap)

The cap 12 is fixed to the hub 28 in order to cover the first air/liquid interface 93 formed between the inner peripheral surface 28f of the hub 28 and the ring member, 104. The cap 12 prevents the lubricant 92 from scattering from the first air/liquid interface 93 to the interior of the device including the disk accommodation space 24.

The cap 12 is provided in an annular step part 30 formed on a mounting surface of the hub 28 (the top surface side in FIG. 2) on which the recording disk 8 is mounted. The annular step 30 is an annular recess having a center which coincides with the rotation axis R. The cap 12 fits in the inner peripheral surface 30a of the annular recess 30 of the hub 28. The cap 12 is placed on the bottom surface 30b of the annular recess 30 and fixed to the hub 28 by an adhesive 98.

The cap 12 is formed by cutting or pressing, for example, a steel material. The cap 12 may be formed by, for example, resin molding. Additionally, the cap 12 may include, for example, a charcoal filter or a porous material such as a sintered material so as to catch a greater amount of the lubricant 92 scattering from the first air/liquid interface 93.

(Dynamic Pressure Generating Part)

A first radial dynamic pressure generating part 81 and a second radial dynamic pressure generating part 82 are formed in an upper portion and a lower portion, respectively, of a space between the outer peripheral surface of the cylindrical part 26b of the shaft 26 and the inner peripheral surface of the shaft surrounding part 28a of the hub 28. The first radial dynamic pressure generating part 81 and the second radial dynamic pressure generating part 82 are separated in the axial direction.

A first radial dynamic pressure generating groove 28g having, for example, a herring bone shape or a spiral shape is provided in a portion of the inner peripheral surface of the shaft surrounding part 28a of the hub 28 facing the first radial dynamic pressure generating part 81. Additionally, a second radial dynamic pressure generating groove 28h having, for example, a herring bone shape or a spiral shape is provided in a portion of the inner peripheral surface of the shaft surrounding part 28a of the hub 28 facing the second radial dynamic pressure generating part 82. Either one or both of the first radial dynamic pressure groove 28g and the second radial dynamic pressure groove 28h may be provided in the outer peripheral surface of the cylindrical part 26b of the shaft 26.

A first thrust dynamic pressure generating part 83 is provided between the top surface of the shaft surrounding part 28a of the hub 28 and the bottom surface of the flange part 26c of the shaft 26. Additionally, a second thrust dynamic pressure generating part 84 is provided between the bottom surface of the shaft surrounding part 28a of the hub 28 and the top surface of the bottom part 102a of the housing 102.

A first thrust dynamic pressure generating groove 28i having, for example, a herring bone shape or a spiral shape is formed in a portion of the top surface of the shaft surrounding part 28a of the hub 28 facing the first thrust dynamic pressure generating part 83. Additionally, a second thrust dynamic pressure generating groove 28j having, for example, a herring bone shape or a spiral shape is formed in a portion of the bottom surface of the shaft surrounding part 28a of the hub 28 facing the second thrust dynamic pressure generating part 84. The first thrust dynamic pressure generating groove 28i may be provided in the bottom surface of the flange part 26c of the shaft 26. The second thrust dynamic pressure generating groove 28j may be provided in the top surface of the bottom part 102a of the housing 102.

When the hub 28 is rotated with respect to the shaft 26 and the housing 102, a dynamic pressure is generated in the lubricant 92 in each of the first radial dynamic pressure generating part 81, the second radial dynamic pressure generating part 82, the first thrust dynamic pressure generating part 83, and the second thrust dynamic pressure generating part 84. Accordingly, the hub 28 can be supported in the axial direction and the radial direction by the dynamic pressure generated in the lubricant 92 in a non-contacting state with the shaft 26 and the housing 102.

Each of the first radial dynamic pressure generating groove 28g, the second radial dynamic pressure generating groove 28h, the first thrust dynamic pressure generating groove 28i and the second thrust dynamic pressure generating groove 28j can be formed by, for example, pressing, ball roll forming, electro chemical machining or cutting by controlling a tool using a piezoelectric device.

Each of these grooves may be formed by a different processing method.

(Inclined Surface on Fitting Part of Hub)

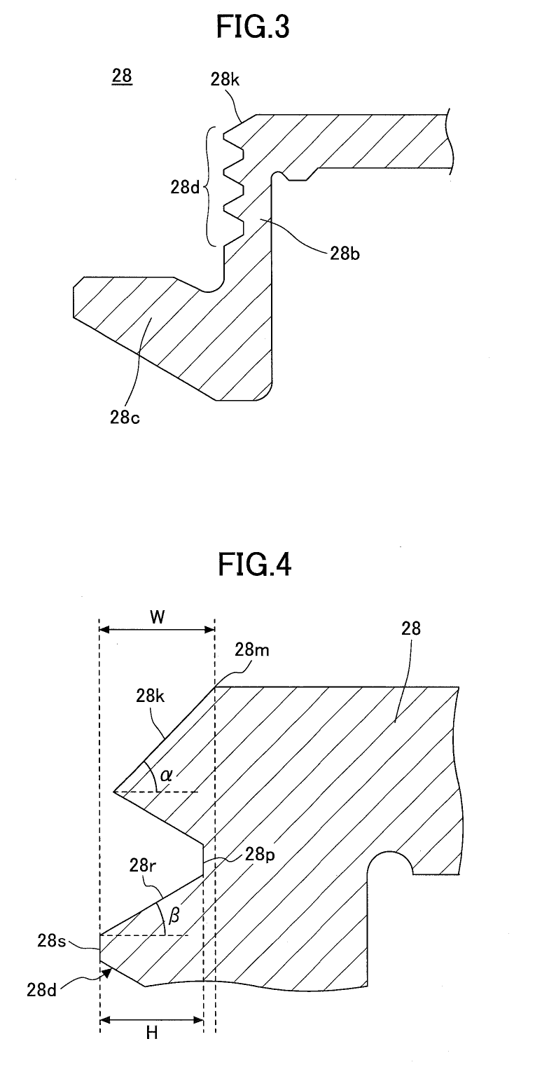

FIG. 3 is an enlarged cross-sectional view of a part of the hub 28.

As illustrated in FIG. 3, an inclined surface 28k is provided on an entire upper-end circumferential edge of the fitting part 28b of the hub 28. An inner peripheral edge of the inclined surface 28k is located closer to the rotation axis R than the deepest part of the external thread groove 28d. The inclined surface 28k is a part of a conical surface (tapered annular surface) having a diametral distance in a plane perpendicular to an axial direction, which coincides with the rotation axis R, gradually increasing in a downward manner.

According to the inclined surface 28k provided in the hub 28, an incomplete thread is not formed on the upper-end portion of the thread groove 28d of the fitting part 28b of the hub 28. As mentioned before, the incomplete thread is a part of the thread formed on the upper-end portion of the fitting part 28b, which part includes an incomplete thread ridge having a sharp top (refer to FIG. 4). Such an incomplete thread is inevitably formed when forming a thread on the fitting part of the rotatable member.

Because the incomplete thread is not formed on the upper-end portion of external thread groove 28d and, thus, there is no problem of deforming the incomplete thread during, for example, the manufacturing process, there is no difficulty in attaching the clamper 36 to the fitting part 28b of the hub 28. Accordingly, it becomes possible to screw the clamper 36 to the fitting part 28b of the hub 28 smoothly, which enables easy fixation of the recording disk 8 to the hub 28. Additionally, there is no problem of the incomplete thread being deformed and cut off and fall inside the disk drive device 100 when screwing the clamper 36 to the fitting part 28b of the hub 28. Thus, a problem caused by the incomplete thread is prevented from occurring.

As mentioned above, in the disk drive device 100 according to the present embodiment, no incomplete thread is formed on the external thread groove 28d due to the inclined surface 28k provided on the upper-end outer circumferential edge of the fitting part 28b of the hub 28. Thus, the problem due to the formation of the incomplete thread is prevented from occurring when fixing the recording disk 8 to the hub 28.

FIG. 4 is an enlarged cross-sectional view of a part of the hub 28 provided with the inclined surface 28k for explaining a configuration and arrangement of the inclined surface 28k.

As illustrated in FIG. 4 and mentioned above, the inner peripheral edge 28m of the inclined surface 28k is located closer to the rotation axis R than the deepest part 28p of the external thread groove 28d. The inclined surface 28k is a prat of a conical surface (tapered annular surface) having a diametral distance in a plane perpendicular to the axial direction gradually increasing in a downward manner.

Here, it is assumed that an angle a is formed between the inclined surface 28k and the plane perpendicular to the axial direction, and an angle β is formed between the slope 28r of the thread of the external thread groove 28d and the plane perpendicular to the axial direction. The angle α of the inclined surface 28k preferably satisfies the following relationship (1).

β≦α≦2β (1)

If the angle α of the inclined surface 28k is excessively small, the incomplete thread is formed in the thread groove 28d. On the other hand, if the angle α of the inclined surface 28k is excessively large, a formation range of the external thread groove 28d in the axial direction becomes small because the external thread groove 28d is not formed in a portion where the inclined surface 28k is formed. Accordingly, the angle α of the inclined surface 28k is preferably set within a range defined by the above relationship (1) depending on the angle β of the external thread groove 28d.

Moreover, it is assumed that a distance W in a radial direction (hereinafter, referred to as the “width W of the inclined surface 28k”) is provided between the top 28s of the thread of the external thread groove 28d and inner circumferential edge 28m of the inclined surface 28k, and the thread of the external thread groove 28d has a height H. In this condition, the width W of the inclined surface 28k preferably satisfies the following relationship (2).

H≦W≦2H (2)

If the width W of the inclined surface 28k is smaller than or equal to the height H of the thread, the incomplete thread is formed in the thread groove 28d. On the other hand, if the width W of the inclined surface 28k is excessively large, there may be a problem in the manufacturing process such that the clamper 36 tends to be screwed to the fitting part 28b of the hub 28 while being inclined with respect to the fitting part 28b. Accordingly, the width W of the inclined surface 28k is preferably set within a range defined by the above relationship (2) depending on the height H of the external thread groove 28d.

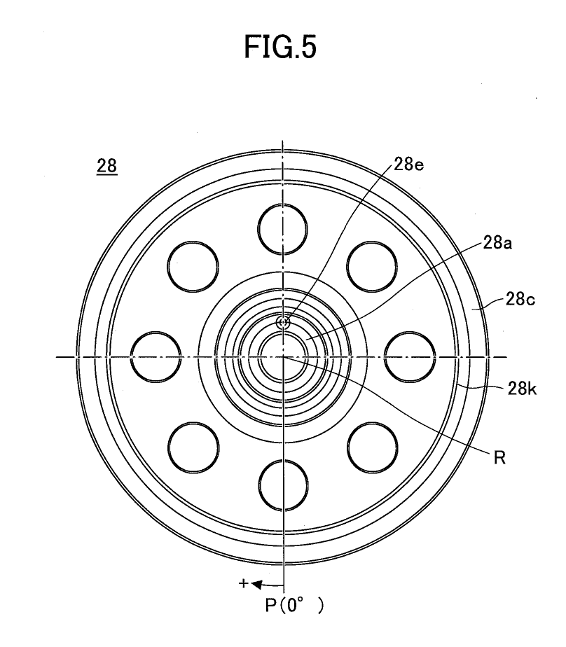

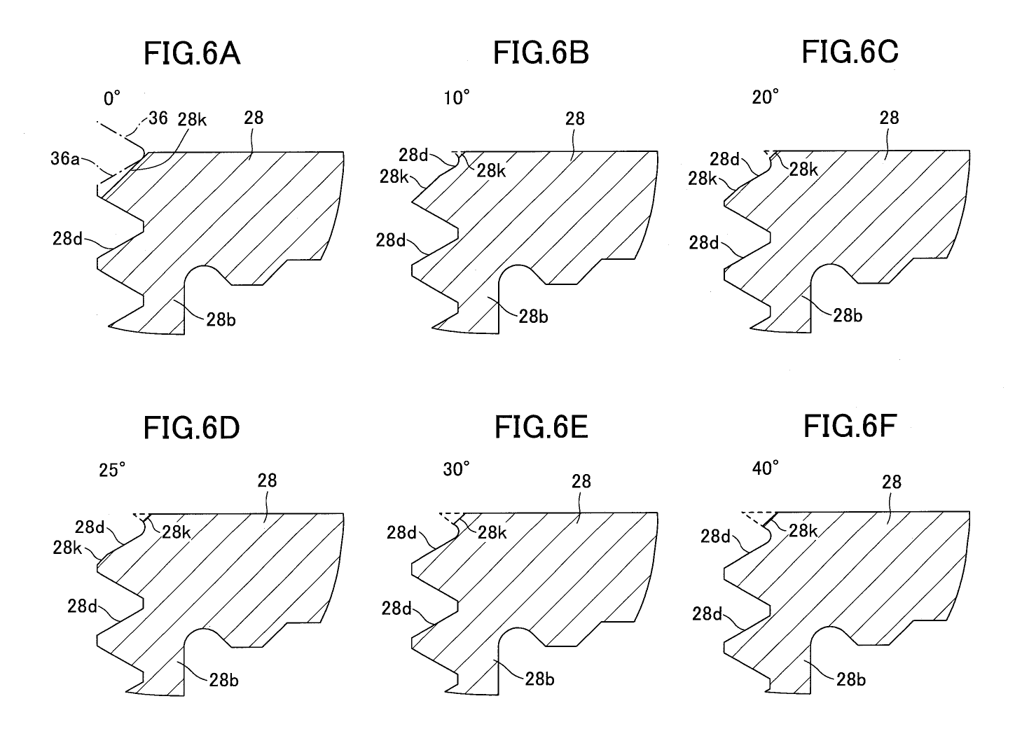

FIG. 5 is a plan view of the hub 28 according to the present embodiment. FIGS. 6A-6F are enlarged cross-sectional views of a portion of the hub 28 having the inclined surface 28k. FIG. 6A illustrates a cross sectional view of the portion of the hub 28 taken along a reference radial line P indicated in FIG. 5. FIGS. 6B-6F are cross-sectional views of the portion of the hub 28 having the inclined surface 28k taken along radial lines shifted from the reference radial line P by 10 degrees, 20 degrees, 25 degrees, 30 degrees and 40 degrees in the clockwise direction indicated by an arrow in FIG. 5.

The formation of the external thread groove 28d begins from a position corresponding to the reference radial line P illustrated in FIG. 6A, and an area where the external thread groove 28d is formed increases in the clockwise direction. Then, a complete thread ridge of the external thread groove 28d is formed at a position corresponding to the cross-sectional view illustrated in FIG. 6F. As illustrated in FIGS. 6A-6F, an incomplete thread, which is indicated by dashed lines in FIGS. 6B-6F, is not formed on the upper-end circumferential edge of the fitting part 28b of the hub 28 according to the present embodiment because the inclined surface 28k is provided on the upper-end circumferential edge of the fitting part 28b.

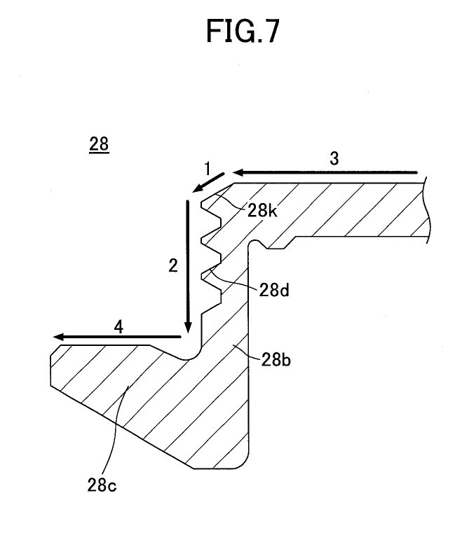

FIG. 7 is a cross-sectional view of a part of the hub 28 for explaining a manufacturing process of the hub 28 according to the present embodiment.

As indicated by arrows 1-4 in FIG. 7, the hub 28 according to the present embodiment is formed by machining a workpiece by a machining tool in an order of the arrows 1-4. That is, the inclined surface 28k is formed first as indicated by the arrow 1 by machining using a cutting tool. Then, the external thread groove 28d is formed on an outer peripheral surface of the fitting part 28b as indicated by the arrow 2. Thereafter, the top surface of the hub 28 is formed by machining as indicated by the arrow 3. Then, the placement part 28c of the hub 28 is formed by machining as indicated by the arrow 4.

If the inclined surface 28k is formed by machining using a machining tool after the external thread groove 28d is formed, it is possible that the thread already formed at the uppermost position of the external thread groove 28d is deformed by a pressing force applied by the machining tool. Accordingly, in order to prevent the thread of the external thread groove 28d from being deformed, it is desirable to form the external thread groove 28d after forming the inclined surface 28k.

The hub 28 fabricated by the above-mentioned manufacturing process is incorporated in the disk drive device 100 according to the present embodiment. The hub 28 does not have an incomplete thread because the inclined surface 28k is provided as mentioned above, and thereby no deformation occurs in the external thread groove 28d. Thus, it is possible to easily screw the clamper 36 to the fitting part 28b of the hub 28.

If an incomplete thread is formed as indicated by dashed lines in FIG. 6, an extreme end of the incomplete thread may be deformed and bent downwards during a manufacturing process of the hub 28. Thus, it may be difficult to screw the clamper 36 to the fitting part 28b of the hub 28. Additionally, if the clamper 36 is forcibly screwed and attached to the fitting part 28b of the hub 28 in a state where the incomplete thread is deformed, the deformed incomplete thread may be cut off and fall inside the disk drive device 100, which may cause a malfunction occurring in the disk drive device 100.

However, in the disk drive device 100 according to the present embodiment, the incomplete thread is not formed in the external thread groove 28d of the fitting part 28b of the hub 28 due to the inclined surface 28k provided on the upper-end circumferential edge of the fitting part 28b of the hub 28. Therefore, the internal thread groove 36a of the clamper 36 is easily screwed to the external thread groove 28d of the fitting part 28b of the hub 28, which results in an improvement in workability in the manufacturing process of the disk drive device 100. Additionally, there is no problem caused by a deformed incomplete thread being cut off and falling inside the disk drive device 100 when attaching the clamper 36 to the hub 28. Thus, according to the disk drive device 100 according to the present embodiment, the above-mentioned possible problems are prevented from occurring when the recording disk is fixed to the hub 28 by screwing the clamp 36 to the fixing part 28b of the hub 28.

The present invention is not limited to the specifically disclosed embodiments directed to the disk drive device, and variations and modifications may be made without departing from the scope of the present invention.

What is claimed is

1. A disk drive device, comprising:
a stationary member including a base; and
a rotatable member rotatably supported by the stationary member about a rotation axis via a dynamic pressure fluid bearing mechanism, the rotatable member including a hub having a cylindrical part configured to fit in a center hole of a recording disk and a placement part protruding radially outward from a first end portion of the cylindrical part in a direction of the rotation axis of the rotatable member, the cylindrical part including an external thread groove formed on an outer peripheral surface thereof,
wherein the cylindrical part further includes a small inner-edge inclined surface, which is a tapered annular surface formed on a second end portion of the cylindrical part opposite to the first end portion so that the external thread groove begins forming from the small inner-edge inclined surface, the small inner-edge inclined surface having an inner circumferential edge at which the small inner-edge inclined surface connects to an end surface of the second end portion of the cylindrical part, the inner circumferential edge having a diameter smaller than a thread bottom diameter defined by a deepest bottom part of the external thread groove.

2. The disk drive device as claimed in claim 1, wherein an angle α formed between the small inner-edge inclined surface and a plane perpendicular to the rotation axis and an angle β formed between a slope of a thread of the external thread groove and the plane perpendicular to the rotation axis satisfy a relationship β≦α≦2β.

3. The disk drive device as claimed in claim 1, wherein a distance W between a top of a thread of the external thread groove and the inner circumferential edge measured in a radial direction of the cylindrical part and a height H of the thread of the external thread groove satisfy a relationship H≦W≦2H.

4. The disk drive device as claimed in claim 1, wherein when a clamper engages with the cylindrical part, each of the external thread groove and the small inner-edge inclined surface has a portion overlapping with an area to be occupied by the clamper in a direction parallel to the rotation axis.

5. The disk drive device as claimed in claim 1, wherein the external thread groove and the small inner-edge inclined surface are formed of a magnetic material.

6. The disk drive device as claimed in claim 1, wherein a plated layer is formed on each of the external thread groove and the small inner-edge inclined surface.

7. The disk drive device as claimed in claim 1, wherein an outer diameter of the external thread groove is smaller than 20 mm, and a maximum diameter of the small inner-edge inclined surface is smaller than the outer diameter of the external thread groove.

8. The disk drive device as claimed in claim 1, wherein the rotatable member includes an annular magnet fixed to an inner side of the hub, and the external thread groove has a portion overlapping with the magnet in a direction parallel to the rotation axis, and wherein the small inner-edge inclined surface is located farther from the rotation axis than the magnet in the radial direction and farther from the base than the magnet in a direction parallel to the rotation axis.

9. The disk drive device as claimed in claim 1, wherein the stationary member includes a stator core fixed to the base, and the cylindrical part includes a portion overlapping with the stator core in a direction parallel to the rotation axis, and wherein the small inner-edge inclined surface is located farther from the rotation axis than the stator core in a radial direction perpendicular to the rotation axis and farther from the base than the stator core in a direction parallel to the rotation axis.

10. The disk drive device as claimed in claim 1, where in the dynamic pressure fluid bearing mechanism includes a radial dynamic pressure generating part, and the external thread groove includes a portion overlapping with the radial dynamic pressure generating part in a direction parallel to the rotation axis, and wherein the small inner-edge inclined surface is located farther from the rotation axis than the radial dynamic pressure generating part in a radial direction perpendicular to the rotation axis and farther from the base than the radial dynamic pressure generating part in a direction parallel to the rotation axis.

11. The disk drive device as claimed in claim 1, where in the dynamic pressure fluid bearing mechanism includes a thrust dynamic pressure generating part, and the external thread groove includes a portion overlapping with the thrust dynamic pressure generating part in the direction parallel to the rotation axis, and wherein the small inner-edge inclined surface is located farther from the rotation axis than the thrust dynamic pressure generating part in a radial direction perpendicular to the rotation axis.

12. A disk drive device, comprising:
a rotatable member rotatably supported about a rotation axis, the rotatable member including a cylindrical part configured to fit in a center hole of a recording disk and a placement part protruding radially outward from a first end portion of the cylindrical part in a direction of the rotation axis;
an external thread groove formed on an outer peripheral surface of the cylindrical part; and
a small inner-edge inclined surface, which is a tapered annular surface formed on a second end portion of the cylindrical part opposite to the first end portion so that the external thread groove begins forming from the small inner-edge inclined surface, the small inner-edge inclined surface having an inner circumferential edge at which the small inner-edge inclined surface connects to an end surface of the second end portion of the cylindrical part, the inner circumferential edge having a diameter smaller than a thread bottom diameter defined by a deepest bottom part of the external thread groove,
wherein an angle α formed between the small inner-edge inclined surface and a plane perpendicular to the rotation axis and an angle β formed between a slope of a thread of the external thread groove and the plane perpendicular to the rotation axis satisfy a relationship β≦α≦2β.

13. The disk drive device as claimed in claim 12, wherein a distance W between a top of a thread of the external thread groove and the inner circumferential edge measured in a radial direction of the cylindrical part and a height H of the thread of the external thread groove satisfy a relationship H≦W≦2H.

14. The disk drive device as claimed in claim 12, wherein when a clamper engages with the cylindrical part, each of the external thread groove and the small inner-edge inclined surface has a portion overlapping with an area to be occupied by the clamper in a direction parallel to the rotation axis.

15. The disk drive device as claimed in claim 12, wherein the external thread groove and the small inner-edge inclined surface are formed of a magnetic material.

16. The disk drive device as claimed in claim 12, wherein a plated layer is formed on each of the external thread groove and the small inner-edge inclined surface.

17. The disk drive device as claimed in claim 12, wherein an outer diameter of the external thread groove is smaller than 20 mm, and a maximum diameter of the small inner-edge inclined surface is smaller than the outer diameter of the external thread groove.

18. A method of manufacturing the disk drive device as claimed in claim 12, comprising:
forming the small inner-edge inclined surface on a workpiece to be formed into the rotatable member; and
forming, after forming the small inner-edge inclined surface, the external thread groove on the workpiece.
